(19) United States
(12) Patent Application Publication
(10) Pub. No.: US 2009/0281753 A1
(43) Pub. Date: Nov. 12, 2009

(54) METHOD AND SYSTEM FOR PHOTOVOLTAIC CELL PRODUCTION YIELD ENHANCEMENT

(76) Inventor: Noam Noy, Natanya (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/414,492

(22) Filed: Mar. 30, 2009

Related U.S. Application Data
(60) Provisional application No. 61/040,914, filed on Mar. 31, 2008.

(51) Int. Cl. G01N 21/88; G06F 19/00

(52) U.S. Cl. 702/81; 356/237.2

(57) ABSTRACT

A system and a method for photovoltaic thin film quality control. The system illuminates an area of photovoltaic film, acquires the illuminated area and compares it with a predetermined i A system and a method for photovoltaic thin film quality control. The system illuminates an area of photovoltaic film, acquires the illuminated area and compares it with a predetermined image. The difference between the images indicates on presence of photovoltaic thin film defects.

### CROSS-REFERENCE TO RELATED APPLICATIONS

This application, which is a non-provisional application being filed under 37 CFR 1.53(b) and 35 USC 111, claims the benefit of the priority date of the United States Provisional Application for patent filed on Mar. 30, 2008 and assigned Ser. No. 61/040,914, which application is hereby incorporated by reference.

### TECHNOLOGY FIELD

The method and system relates to the area of yield enhancement of photovoltaic cell thin film production processes and in particular to production of thin film photovoltaic cells.

### BACKGROUND

Thin film (TF) layers are typically layers of metal, semiconductor, or organic material having a high degree of surface uniformity. The layers are produced by depositing the desired material on a flexible or rigid substrate. The substrates may have a variety of sizes ranging from microscopic integrated circuits to large solar panels having dimensions of tens of meters. The substrates may be rigid or flexible, precut sheets or continuous web material. The layers may be deposited by sputtering, electrolytic deposition, printing, or other processes known in the art and may be transparent, translucent, opaque or reflective.

In order to ensure proper functionality, the TF layer should be homogeneous and free of defects such as pinholes, bumps, dish downs, scratches, shorts, cuts etc. A range of complicated production processes and systems that combine partially integrated and stand-alone material deposition systems, optical inspection systems, metrology measurement systems, repair devices etc., are typically used to ensure the integrity of the TF layer or to locate the defects and remove the defective sections of material from the process.

The task becomes more complicated as the size of the substrate increases. For example, PV (Photovoltaic) TF production uses substrates of larger size than Flat Panel Displays (FPD) substrates. Gen 6 FPD substrates and some later FPD generations may be as large as 220-260 centimeters and thin-layer solar photovoltaic panels, which are used to convert light energy into electricity, may have dimensions of a few meters. The above mentioned defects significantly reduce production yield and increase the cost of finished products. The yield is especially important in the solar panel market undergoing rapid growth and wherein removal of the defects improves solar panel efficiency and in many cases saves a complete solar cell from being disposed of as a malfunctioning cell.

The industry still does not possess a fully automated integrated solar panel production line. It is searching for solutions that could enable effective production defect detection and classification, and further support a repair capability. The repair is needed to remedy and fix defective panels having the above mentioned defects. Such systems could be part of new production lines or additions to those already existing, and, will also increase the produced photovoltaic modules efficiency, correlating with the percentage of light energy converted to electricity.

### BRIEF SUMMARY

A system and a method for photovoltaic thin film quality control. The system illuminates an area of a continuously moving photovoltaic film, acquires the illuminated area and compares it with a predetermined defect free image. The difference between the images indicates the presence of photovoltaic thin film defects. The processes of image acquisition, defect detection and classification, geometric feature analyses, and others are concurrent processes performed without slowing the speed of continuously moving photovoltaic film. The system communicates the detected defects to located upstream and downstream thin film production systems and undertakes corrective actions, improving the yield of a thin film production line.

### GLOSSARY

The term “auxiliary image” as used in the present disclosure means an acquired image illuminated by one type of illumination, or characterized by one type of image field, or a combination. For example, an image obtained by green light illumination using bright field method or an image obtained by dark field or bright field methods would be auxiliary images. An auxiliary image would typically be an image of a line illuminated by any one of the illumination sources.

The term “combined image” as used in the present disclosure means an image generated by a manipulation of two or more auxiliary images.

The term “time slice” as used in the present disclosure means time in course of which one line of one auxiliary image is exposed to a selected illumination.

The term “Line time” as used in the present disclosure means a sum of time slices comprising the particular line and transition time between the lines.

The term “Area type” as used in the present disclosure means a designated portion of the produced web or sheet with predetermined geometric and thin film layer structure characteristics. A current collection line is an example for an “area type”.

The term “Illumination field type” as used in the present disclosure means an illumination field such as a “dark field” or “bright field” created by a light source.

The term “Light source type” as used in the present disclosure means the type of the emitted light such as Infra Red, Red, Green or Blue.

The term “repair” or “defect correction” as used herein means at least one of isolating material addition, conductor material addition, semiconductor material addition, excessive material removal including metal conductors.

The term “Present Method Logic” as used herein means multiperspective imaging (MPI) a technique combining what is seen from multiple perspective or viewpoints into a single image. The multiperspective images can preserve and depict, within a single context, details of an image that are simultaneously inaccessible from a single view, yet easily interpretable by a viewer or a computer.

The term “article” as used herein means a substrate coated with a thin film coating.

Defect “classification” is a process of association of defects detected in the course of TF layer inspection to predetermined defect types.

Fast switching light sources are LEDs, laser diodes, and sources implemented by a source of a “permanent” light such as an incandescent or metal halide lamp configured with Digital Micromirror Device (DLP).

Any production process that takes place before the thin layer inspection is termed “upstream process” and any process that takes place after the thin layer inspection is termed “downstream process.” Accordingly, such processes are performed on located upstream or downstream workstations.

### BRIEF LIST OF DRAWINGS

The system and the method, both as to organization and method of operation, may best be understood by reference to the following detailed description when read with the accompanied drawings, in which like reference characters refer to the same parts throughout the different views. The drawings are not necessarily to scale, emphasis instead being placed upon illustrating the principles of the system and the method.

FIG. 1A and FIG. 1B, collectively referred to as FIG. 1, are schematic illustrations of some exemplary thin film layer production defects.

FIG. 2 is a table demonstrating in graphical form the drawbacks of the known illumination methods and provides a summary of the advantages of the present method.

FIG. 3 is a schematic illustration of an exemplary embodiment of a thin film production line with improved thin layer production yield.

FIG. 4A, FIG. 4B and FIG. 4C, collectively referred to as FIG. 4, are schematic illustrations of some exemplary embodiments of the present system for thin film layer quality control and yield improvement.

FIG. 5 is a schematic illustration of an exemplary embodiment of a fast switching light source based illumination unit such as Light Emitting Diodes (LED) or solid-state lasers.

FIG. 6 is a schematic illustration of another exemplary embodiment of fast switching light source based illumination unit.

FIG. 7 is an exemplary schematic timing diagram of scanning lines acquisition in a sequential line acquisition mode.

FIG. 8A, FIG. 8B, FIG. 8C, FIG. 8D and FIG. 8E, collectively referred to as FIG. 8, are schematic illustrations of an acquired line from a Line Charged Coupled Device (LCCD) element to auxiliary image storage transfer via an Analog Shift Register (ASR).

FIG. 9 is a schematic illustration of the process of a sequentially acquired combined image pixel formation.

FIG. 10A, FIG. 10B, FIG. 10C and FIG. 10D, collectively referred to as FIG. 10, are exemplary schematic timing diagrams of scanning lines acquisition in a combined lines acquisition mode.

FIG. 11 is a schematic illustration of the process of a concurrently acquired combined image pixel formation.

FIG. 12 is a schematic illustration of the inter relations between the setup, defect detection and classification modules.

### DETAILED DESCRIPTION OF THE EXEMPLARY EMBODIMENTS

In the following detailed description, reference is made to the accompanying drawings which form a part hereof, and show by way of illustration specific embodiments where the system and method may be practiced. In this regard, directional terminology, such as “top,” “bottom,” “front,” “back,” “leading,” “trailing,” etc., is used with reference to the orientation of the figure(s) being described. Because components of embodiments of the present apparatus can be positioned in a number of different orientations, the directional terminology is used for purposes of illustration and is in no way limiting.

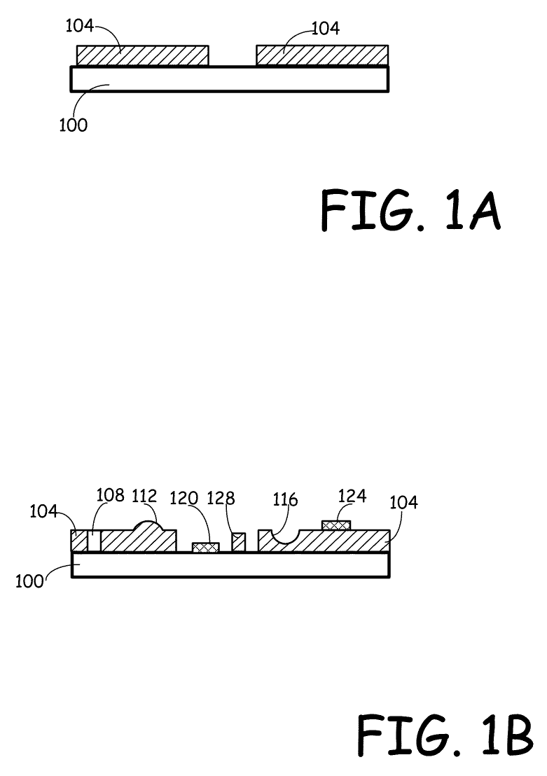

Thin film layers or coating production processes may produce transparent, translucent, opaque or reflective layers. As with any other production process the TF production is not free of defects. FIG. 1 is an exemplary illustration of some thin layer production defects. FIG. 1A illustrates a substrate 100 coated by a defect free reflective coating 104. FIG. 1B illustrates the same substrate 100 coated by a reflective coating 104 to which, for the purpose of explanation, some of the possible manufacturing defects have been introduced. The following non-limiting examples of defects may be present on such coating: pinholes 108, bumps 112, dish downs 116, contaminations 120 and 124, reflective spots on transparent substrate or coating 128, etc. FIG. 1A and FIG. 1B illustrate substrate 100 with a reflective coating, although similar to the earlier described defects may be present on a transparent coating. For the simplicity of illustration FIG. 1A and FIG. 1B show patterned coating, but it should be noted that similar defects exist in uniform coatings. In order to improve production yield these and other defects should be identified, located and repaired or corrected during the photovoltaic thin film layer production process. Different illumination source and illumination types or schemes are used for the detection of the defects. Not one of the illumination types or schemes satisfies or is capable of detecting all or even a majority of the defects present in a thin layer and, more importantly, enable defect classification.

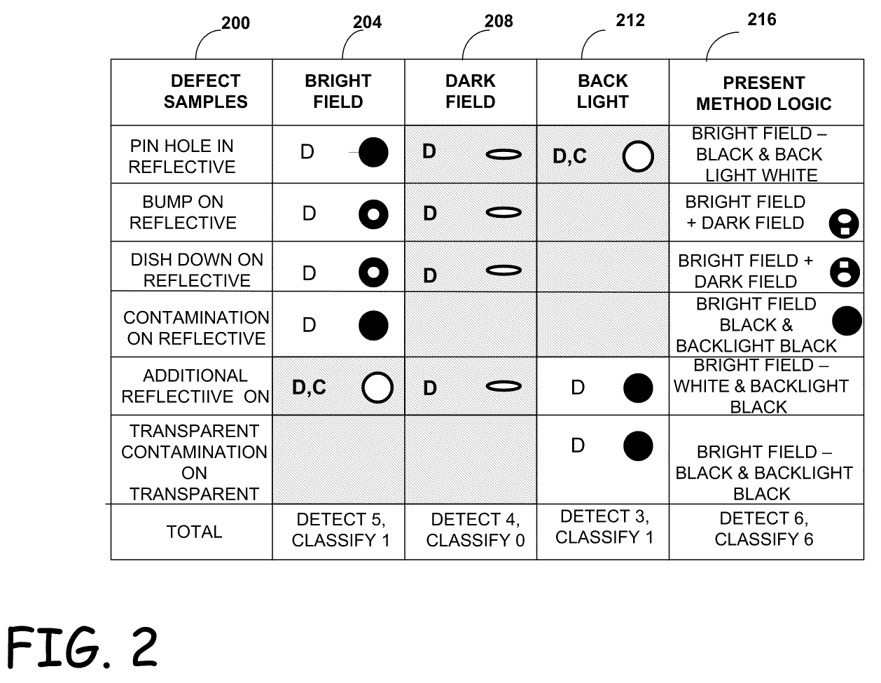

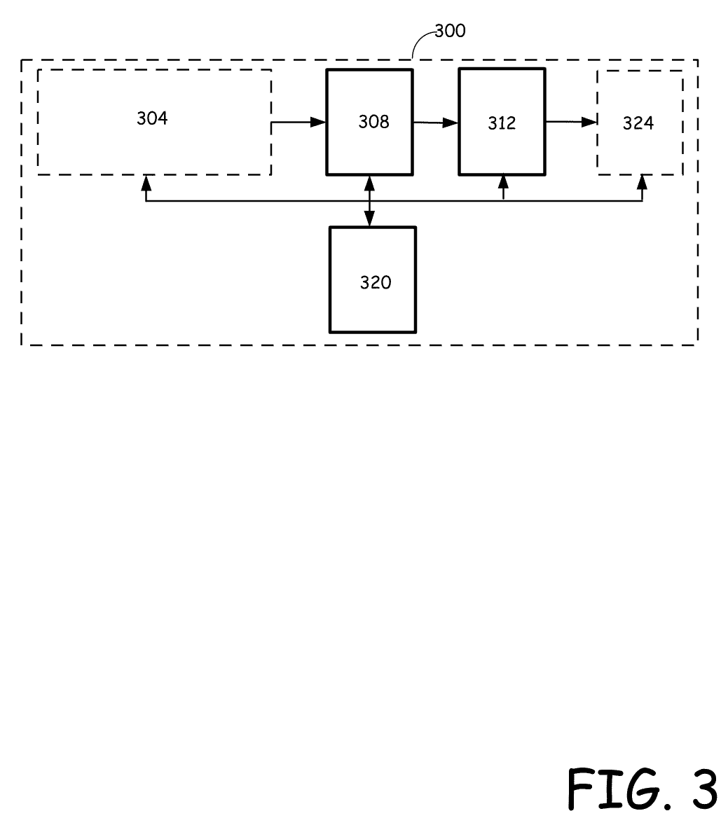

For example, bright field illumination enables detection of pinholes in a reflective coating and bumps on a transparent coating. However, it does not support the defect classification, because both the pinholes and bumps have an identical appearance in the field of view of the optical system. Table 1 indicates known illumination source types or schemes and their drawbacks, where FIG. 2 provides a graphical representation of known illumination source types or schemes and their drawbacks.

Bright field illumination (column 204) enables detection of five types of defects but helps in classification of only one of them. Dark field illumination (column 208) enables detection of four types of defects, although it does not enable classification of the detected defects (column 200). Backlit illumination (column 212) is of use in detection of three types of defects, but supports classification of only one of them. Generally, Table 1 shows that none of the existing illumination techniques alone is capable of detecting all mentioned defects. The classification ratio of the detected defects is poor. It is also necessary to mention that because some of the defects are micron-sized they are difficult to detect while 100% inspection of the controlled parts area is required. The usage of multiple illumination sources assisting in classification of the detected defects increases the likelihood of reaching a successful classification. The goal of such a setup is selection of a minimal number of illumination sources enabling classification of all types of defects in a predetermined thin layer.

TABLE 1

| | Illumination type | | | |
|---|---|---|---|---|
| Type of Defect | Bright field | Dark field | Backlit | Present Method Logic |
| Pinhole in | Can be | Can be | Can be | Combination of bright |
| reflective | detected but | detected but | detected and | Field and Backlit |
| coating | not classified | not classified | classified | creates a unique and |
| (108 in FIG. | | | | recognizable shape |
| 1.B) | | | | |
| Bumps on | Can be | Can be | Cannot be | Combination of Bright |
| reflective | detected but | detected but | detected and | Field and Dark Filed |
| coating | not classified | not classified | classified | creates a unique and |
| (112 in FIG. | | | | recognizable shape |
| 1.B) | | | | |
| Dish downs on | Can be | Can be | Cannot be | Combination of Bright |
| reflective | detected but | detected but | detected and | Field and Dark Filed |
| coating | not classified | not classified | classified | creates a unique and |
| (116 in FIG. | | | | recognizable shape |
| 1.B) | | | | |
| Contamination | Can be | Cannot be | Cannot be | Bright Field and |
| on reflective | detected but | detected and | detected and | Backlit creates a |
| coating | not classified | classified | classified | unique and |
| (124 in FIG. | | | | recognizable shape |
| 1.B) | | | | |
| Reflective | Can be | Can be | Can be | Bright Field and |
| spots on | detected and | detected but | detected but | backlit creates a |
| transparent | classified | not classified | not classified | unique and |
| coating | | | | recognizable shape |
| (128 in FIG. | | | | |
| 1.B) | | | | |
| Contamination | Cannot be | Cannot be | Can be | Combination of Bright |
| on transparent | detected and | detected and | detected but | Field Backlit creates a |
| coating | classified | classified | not classified | unique and |
| (120 in FIG. | | | | recognizable shape |
| 1.B) | | | | |
| Defect | Detects 5 types | Detects 4 types | Detects 3 types | Detects and |
| detection and | of defects, but | of defects, but | of defects, but | classifies all 6 types |
| classification | classifies one | does not | classifies one | of defects described |
| potential | only | classify them | only | |

FIG. 3 is a schematic illustration of an exemplary embodiment of a thin film layers production line 300 with improved thin film layer production yield. Line 300 includes some substrate handling devices that are know in the art, material deposition devices such as sputtering devices, liquid coating devices or similar and other devices or systems required for thin layer production process collectively marked by numeral 304. Substrate (not shown) may be a web substrate or a sheet substrate of any desired size. Upon completion of the thin film coating or layer deposition process, coated substrate is translated to a system 308 for coated layer quality control. System 308 performs thin film quality control and generates data for TF layer repair system 312 and process correction data for the preceding process steps. The data may be fed back directly from system 308 to other systems and devices on production floor or to a control computer 320 that will sort the data according to the production process and distribute it to appropriate production step, device or system. Repaired and defect-free coated substrates proceed to the next production step or device 324 of line 300.

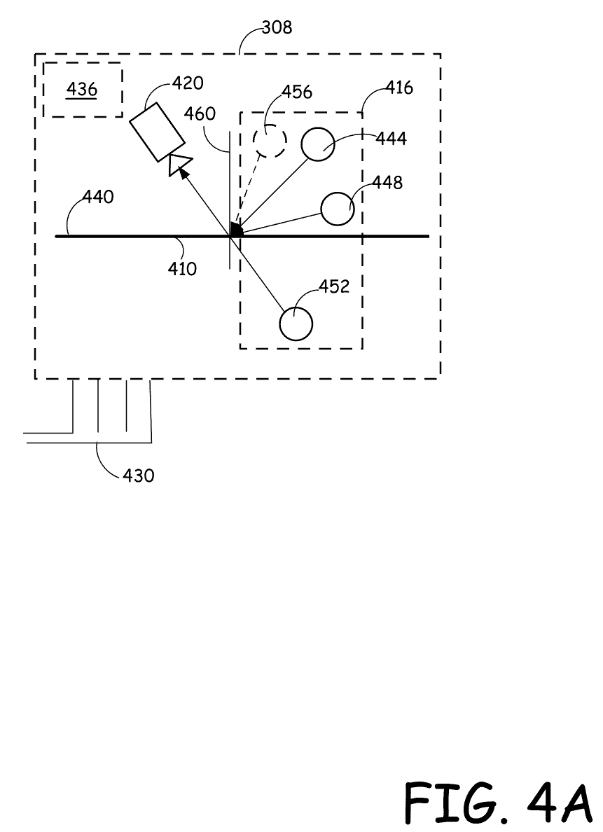

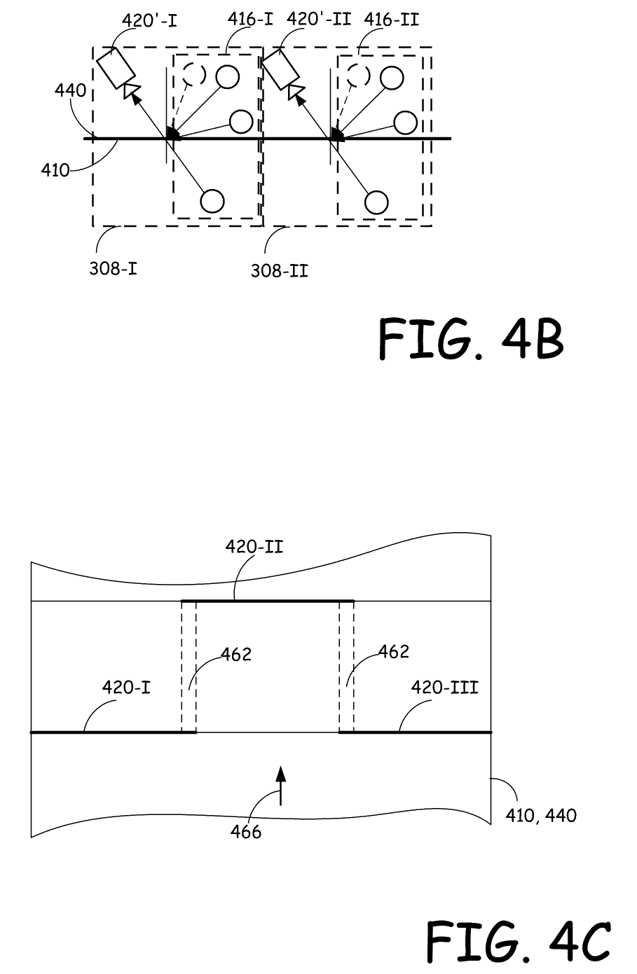

FIG. 4A is a schematic illustration of an exemplary embodiment of the present system for TF layer quality control and yield improvement. System 308 includes a substrate translation device (not shown for the simplicity of explanation) such as a conveyor or a moving surface supporting the controlled substrate 410, with TF layer 440 deposited on it, illumination unit 416, image acquisition and processing device 420, and one or more communication links 430 to other units and devices of production line 300. In an alternative embodiment, system 308 includes a local processor 436 that controls the operation of system 308 and communicates with other units and devices of production line 300. System 308 may be an in-line unit of thin layer production line 300 or may be configured as a stand-alone unit adapted for off-line use with existing production lines.

Illumination unit 416 of quality control system 308 consists of a plurality of illumination sources with each source having different illumination characteristics. Such characteristics for example, may be illumination source intensity, wavelength, polarization, incidence angle, illumination duration and a combination thereof.

At least one illumination source 444 could be configured to produce a bright field illumination on layer 440 deposited on substrate 410. Additional sources may also be used, such as (a) illumination source 448 configured to produce a dark field illumination and/or (b) illumination source 452 configured to provide a backlit illumination and/or transmission illumination. An additional illumination source 456 is configured to illuminate layer 440 with infrared radiation. All illumination sources are configured to illuminate a line rather than a spot on layer 440. (It should be noticed that the illuminated line is not shown in FIG. 4A, since it is perpendicular to the plane of the drawing.) The length of the illuminated line matches or exceeds at least one dimension of thin film layer 440. For example, for web material it would be the width of the web passing below image acquisition and processing device 420, or at least a line that could be properly imaged by the image acquisition and processing device 420. Illumination unit 416 is configured such that all illumination sources illuminate either sequentially or concurrently the same line on layer 440. It is necessary to mention that the same type of light source may be used to illuminate the image from different directions and more than one light source type may illuminate an image from a single direction.

Illumination sources 444-456 of illumination unit 416 are arranged such that they allow the building of a required optical setup most appropriate for a particular TF layer quality control conditions. For example, in case of need the incidence angles defined as the angle between the incident beam and a perpendicular 460 to the incidence point may be adjusted. The number of illumination sources used supports proper illumination spectrum selection providing a variety of wavelengths to be used in the TF production control process.

All of the illumination sources are operative to illuminate layer 440 for at least one time slice, although the time slice varies for each illumination source and to some extent depends on the characteristics of the image acquisition device 420. Two or more of the illumination sources may operate simultaneously, illuminating the same line with a plurality of wavelength and/or types of illumination.

Illumination sources 444-456 may be monochromatic or broadband sources such as LED's, laser diodes, quartz-halogen or metal-halide lamps and others. An appropriate selection of emission spectrum of these sources illuminating an identical location—line allows a desired spectral mix to be built up. Sources 444-456 may be arranged such as to illuminate a line on coated layer 440. Multi-fiber beam shape transformer with optional cylindrical optics (refractive or reflective) could be used to assist in forming the desired illuminated line. Such shape transformer having, for example, a circular input shape and linear output shape (at the article side) may be produced as a bundle of fibers. Such fiber bundles are manufactured by many companies, for example Schott AG, 55120 Mainz Germany, Dolan-Jenner Industries, Inc., Boxborough Mass. 01719 U.S.A., and others. Optionally, system 308 may include at least one illumination source providing polarized illumination of desired amplitude and phase characteristics (not shown).

As noted above, articles may have large dimensions that could be difficult to capture by a single camera or proper illuminate by the illumination source such a relatively long line. FIG. 4B shows a system consisting of a number of butted systems 308-1 and 308-II configured, for example, in two groups where numerals 308-1 through 308-n mark all uneven system numbers and numerals 308-II through 308-2n mark all even system numbers. Each of systems 308 includes at least illumination units 416-1 through 416-II and respective cameras 420′-1 to 420′-II. The illumination sources and the cameras are configured to illuminate and capture sections of the same line. The sections may have certain overlap 462 (FIG. 4C) between them. Lines 420-1 through 420-III mark the field of view for respective cameras 420′-1 through 420′-III. Arrow 466 shows the controlled article or thin film 440 movement direction. (It should be noted that the illuminated lines 420′-1 through 420′-III are not shown in FIG. 4B, since they are perpendicular to the plane of the drawing.)

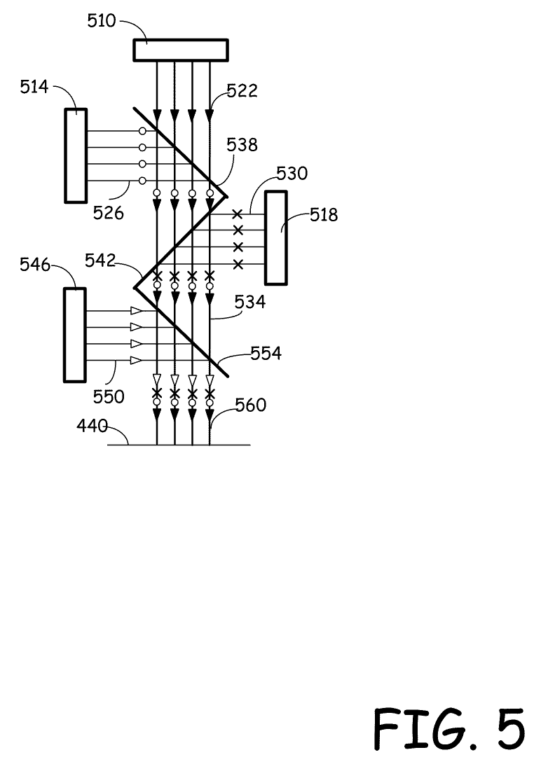

FIG. 5 is a schematic illustration of an exemplary embodiment of a fast switching illumination source such as solid state lasers or LEDs based illumination unit. Blue, Green, and Red illumination sources respectively marked by referral numbers 510, 514, and 518 provide Blue 522, Green 526, and Red 530 illumination beams combined in one illumination beam 534 with the help of dichroic or similar beam combiners 538 and 542. An infrared illumination source 546 provides an infrared beam 550 that is mixed with beam 534 by a beam combiner 554 into one illumination beam 560. Beam 560 illuminates a line on layer 440. Additional optics of any required type that could be used to form an illumination line of desired quality is not shown.

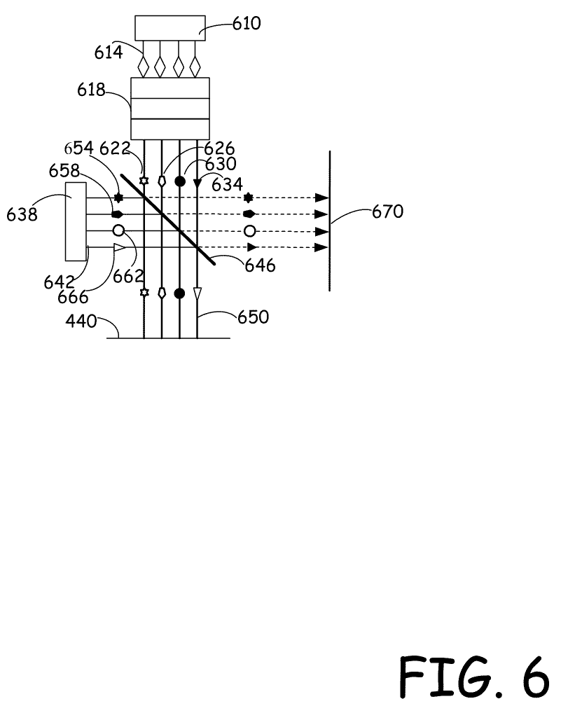

Slow switching light sources like metal halide lamps or similar require additional modulation devices. In addition, certain optics should be used to convert the usually circular beam into an illuminated line. For example, metal halide (or quartz-halogen) lamps radiation may be modulated in time using a standard DLP that can be based on projection technique commercially available from Texas Instruments, Inc., Dallas Tex. U.S.A. (http://www.dlp.com/). Both standard configurations of “three chip” and “one chip” DLP projectors may be used. FIG. 6 is a schematic illustration of an exemplary embodiment of a DLP based illumination unit. Spot to line conversion can be implemented among others by a specific configuration of fiber bundles such as those commercially available from Schott AG, 55120 Mainz Germany, Dolan-Jenner Industries, Inc., Boxborough Mass. 01719 U.S.A. and others.

A metal halide light source 610 directs a “white” light beam 614 onto a three chip DLP projector 618 that provides individually time controlled Red 622, Green 626, and Blue 630 light beams. “Cold” mirror 646 is arranged at an angle such that it “filters out IR radiation present in each metal halide light source. Mirror 646 transmits the visible R, G, B illumination components 622, 626, 630 of beam 614, such that they are mixed with beam 650 where the IR component 634 is reflected onto a radiation absorbing screen 670. An additional metal halide light source 638 provides a broad band time controlled beam 642. The IR component 666 of time modulated beam 642 is mixed into the combined time modulated beam 650 whereas the visible components of beam 642 RGB 654, 658 and 662 are transmitted into screen 670. The components 622, 626, 630 and 666 are combined into one beam 650, which illuminates a line on layer 440.

Image acquisition and processing device 420 (FIG. 4) of control system 308 (FIG. 3) is equipped by imaging optics (not shown) and is configured to image the illuminated line on TF layer 440 and to acquire each of the line images, termed auxiliary images (in certain cases auxiliary images may be two dimensional images), illuminated by at least one type of illumination provided by unit 416. The auxiliary images are acquired sequentially or concurrently. Device 420 acquires the images and concurrently processes them, classifies detected defects, and communicates processing results to at least one production station. Such station or unit may, for example, be a TF layer defect correction or repair station, a statistical process control module or similar. Communication links existing between stations and units of the system facilitate image processing results transfer.

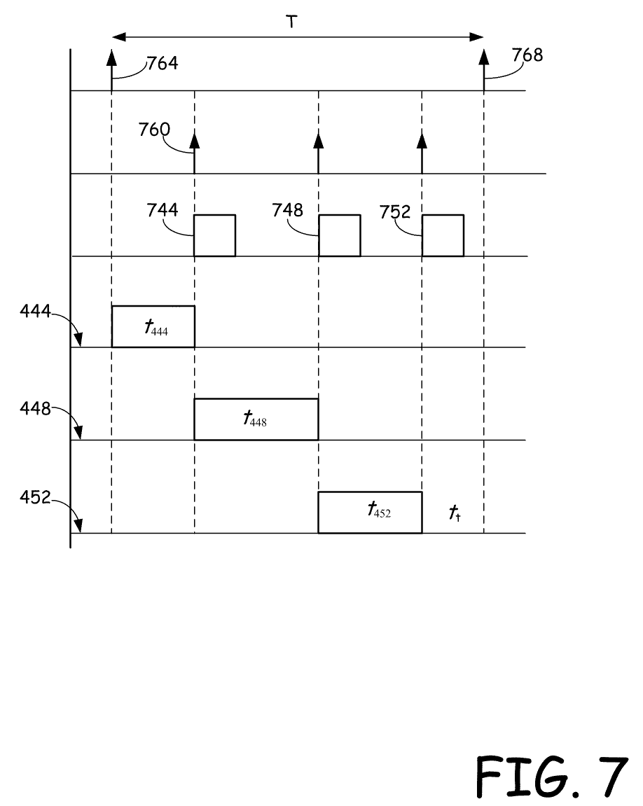

As noticed, the auxiliary images are acquired sequentially or concurrently. For every acquired line of the scanned image each light source is applied to meet its own accumulation time. FIG. 7 is an exemplary schematic timing diagram of scanning lines in a sequential line acquisition mode. In the sequential line acquisition mode each of illumination sources 444-456 operates independently to create an image associated with it. The operational times t₄₄₄-t₄₅₆ of each of the sources 444-456 or any other combination of sources may be equal or different from each other as required by the optimal exposure time of image acquisition and processing unit 420.

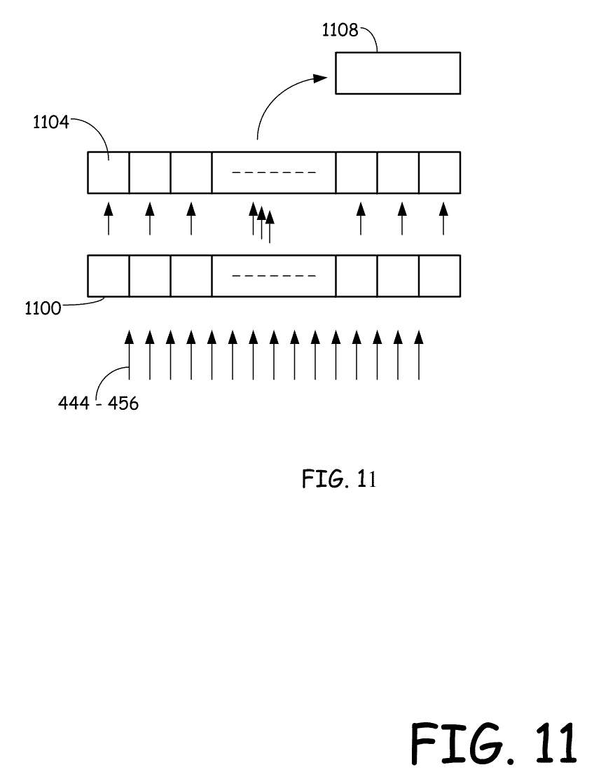

Since in the course of sequential image acquisition process the inspected substrate moves with respect to the sensor 420 (FIG. 4) there exists a phase shift between each sequentially acquired scanning line image. For example, three illumination sources 444, 448, and 452 are operative to sequentially illuminate the same target area or line i. Each of the sources is operative for a respective time slice t₄₄₄, t₄₄₈, and t₄₅₂. Assuming that source 444 is operative first and the image acquisition unit acquires the illuminated by source 444 image into CCD line 1100 (FIG. 11). The acquired CCD line 1100 is transferred to the Analog Shift Register (ASR) 1104 concurrently with the completion of the acquisition of the image illuminated by source 444. The transfer time of an acquired CCD line 1100 to ASR 1014 is negligible (less than 500 nano seconds) compared to the time slice t₄₄₄ for example. The second source 448 will be activated concurrently with the acquisition of line i, illuminated by source 448 and the data of previously acquired line (illuminated by source 444) will be transferred from ASR 1104 into auxiliary image storage 1108. Similar process will be repeated for the other illumination sources. Upon completion of line i acquisition the system proceeds to the acquisition of the next (i+1) line. The phase shift between the acquisition of two sequential images of the same line illuminated by different illumination sources could be determined as:

PS(444,448)=(t₄₄₈/T)*Pixel size,
Where PS is the phase shift between the images produced by sequential application of illumination sources 444 and 448, and T is the line time equal to the sum of time slices (t₄₄₄+t₄₄₈+t₄₅₂+tₜ), where tₜ is transition time from line i to the next (i+1) line.

In a similar way phase shift between images generated by illumination sources 448 and 452, and sources 444 and 452 may be defined:

PS(448,452)=(t₄₅₂/T)*Pixel size, and PS(444,452)=(T−t₄₄₈−t₄₅₂)/T)*Pixel size.
Knowledge of the phase shift between images generated by sequential operation of different light sources enables correlation of the images down to a zero phase shift provided that T>/=(t₄₄₄+t₄₄₈+t₄₅₂).

Numerals 744, 748 and 752 mark the process of data read out from the ASR 1104 into the auxiliary images storage 1108, respectively acquired by using the illumination sources 444, 448, and 452. The transfer time of the data from ASR 1104 into auxiliary images storage 1108 (FIG. 11) is the same for all the transfers indicated by 744, 748 and 752. Part of the time the camera of the image acquisition and processing unit 420 is operative to acquire the images. Numeral 760 marks the move of image from camera to ASR. Reference number 764 marks beginning of line (i) and reference number 768 beginning of line (i+1).

The actual illumination time slice such as t₄₄₄, t₄₄₈ or t₄₅₂ can be shorter than the transfer time 744. In such a case the ASR 1104 (FIG. 11) is still transferring the data resulted from illumination source 444 into the auxiliary images storage 1108, while an illumination source 448 for example completed. For such cases it will be better to define the time slice for illumination source 448 as the maximum between time slice t₄₄₄ transfer rate 744.

First illumination source 444 is applied to line (i) for respective detector (CCD) accumulation time. Concurrently with the acquisition of the line, the image of that line, moves to an analogue shift register (ASR) of the CCD. Next, illumination source 448 is applied to the same line or target area for its own accumulation time. Concurrently the image of line (i) is read from the ASR and stored as “first auxiliary image” of line (i). The process is repeated for the remaining illumination sources with all of the sources illuminating the same line or target area by the required type of illumination. Following completion of line (i) acquisition system control proceeds to the acquisition of the next (i+1) line and so on until the complete panel/frame image is acquired.

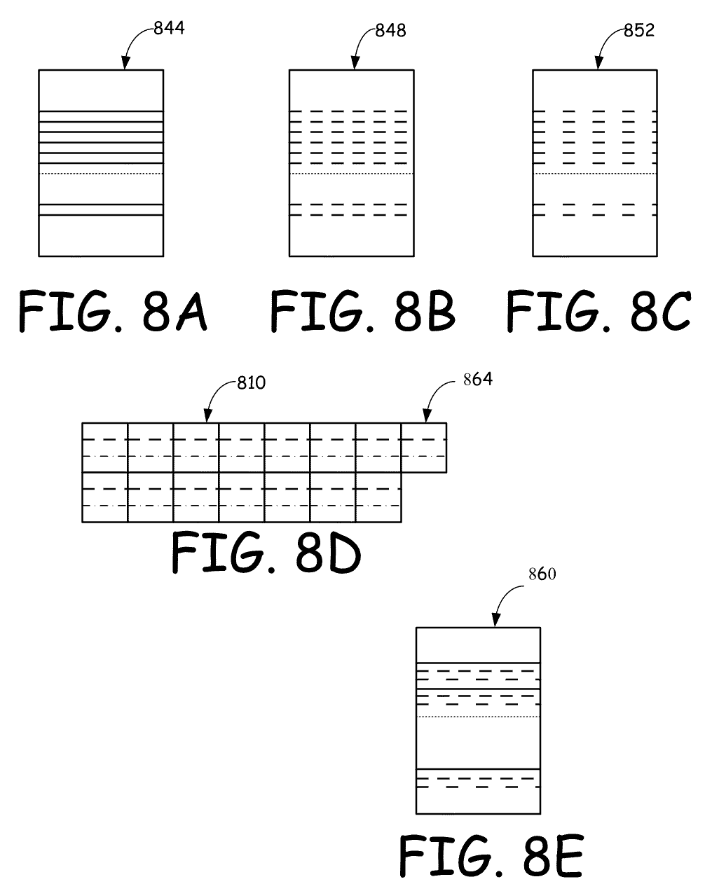

FIG. 8 is a schematic illustration of the process of sequentially acquiring more than one auxiliary image to form an aggregated pixel formation. Numeral 844 (FIG. 8A) marks auxiliary image generated by illumination source 444 and numerals 848 and 852 (FIGS. 8B and 8C) mark auxiliary images respectively generated by sources 448 and 452. FIG. 8D illustrates a combined image pixel formation. Numerals 844, 848 and 852 represent the logical format of the acquired images, each comprised of image lines generated by a single illumination source. Numeral 860 (FIG. 8E) represents the actual layout of the acquired auxiliary images physically residing in the memory. The imaged lines are stored in a line interleave manner, meaning: Line1 from image1, line1 from image 2, line1 from image 3, line 2 from image1 and so on. Numeral 864 illustrates the phase shift created between the lines originated between each different auxiliary image. The algorithm of phase correction is described hereunder.

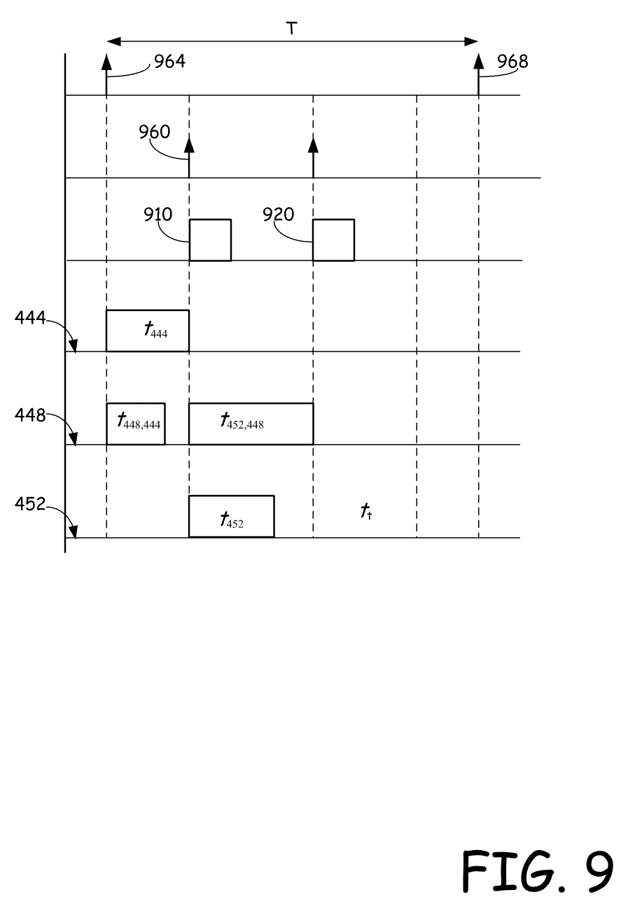

FIG. 9 is a schematic timing diagram of scanning lines (images) acquisition in a combined image (lines) acquisition mode, where at least two or more illumination sources operate concurrently to illuminate the image to be acquired. Similar to the sequential image acquisition process, period t₄₄₄, t₄₄₈, and t₄₅₂ may be equal to each other or of different duration as could be required by the image acquisition sensor. In such case where each of sources 444-452 operation periods t₄₄₄, t₄₄₈, and t₄₅₂ are different, the period of auxiliary line image acquisition should be equal to the maximal period of the two or more illumination sources that operate concurrently. The same illumination source depending on particular operative combination of illumination sources may be operative for different periods governed by the required image properties, nature of the scanned material, sensor properties and some other variables.

The phase shift between images illuminated by a combination of illumination sources 444 and 448 may be expressed as:

PS((444,448),(448,452))=(Max(t₄₄₄,t_{(444,448)})/T)*Pixel Size.
The phase shift between the images illuminated by illumination sources 444 and 452 may be expressed as:

PS((444,448),(448,452))=1−(Max(t₄₄₄,t_{(444,448)})/T)*Pixel Size and between images (lines) illuminated by sources 448 and 452, and between images (lines) illuminated by sources 444 and 448 will be PS((448,452),(444,448))=(1−PS((444,448),(448,452))). The dependence expressed by the above equations enables correlation of the auxiliary images down to a zero phase shift. Line time T in this case is T>=(Max(t₄₄₄,t_{(444,448)}))+(Max (t₄₅₂,t_{(448,452)})).

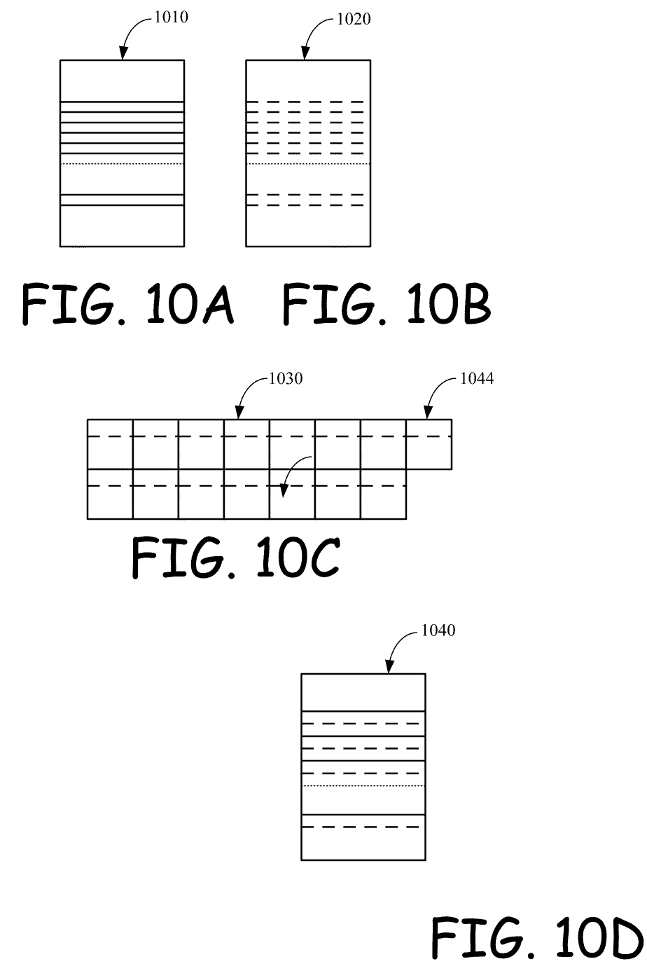

FIG. 10 is a schematic illustration of the process of a concurrently acquired combined image pixel formation. Numeral 1010 marks image generated by concurrent illumination of sources 444 and 448, and numeral 1020 marks image generated by concurrent illumination of sources 448 and 452. FIG. 10C illustrates combined image pixel 1030 formation. Numeral 1040 illustrate the phase shift created between the lines originated between each different auxiliary image.

Simultaneously with the acquisition of a plurality of auxiliary images corresponding to one or more of the illumination sources, processing of the images takes place. This processing may include generation of a phase correction factor and initiating pointers to each of the auxiliary images acquired. The correction factor and pointers will be used in the generation of the next target area and combined image. Following generation of a combined image it may be compared to a stored predefined (defect free) image and the deviations between the captured image and the predefined image may be determined. The number of these deviations and their magnitude indicate coating layer quality.

A process of system parameter set-up precedes the image acquisition process. The process of system parameter set-up includes at least one of setting a list of auxiliary images to be used for a current job and operating parameters of the images, target area type, illumination type, and an algorithm of the image geometrical measurements determination. The target area type may be at least one of cell area, separating line area, laser drills, current collection “fingers,” and determination of an image most suitable for image geometry measurements. The system parameters acquired during the set-up process will be archived and used in the course of production for inspection and geometrical measurements purposes. Previously archived setup parameters can be reused for similar future jobs. Generally, the above disclosed setup processes enable selection of a minimal number of illumination sources and their combination supporting optimal detection of defects that are existing in the inspected thin layer.

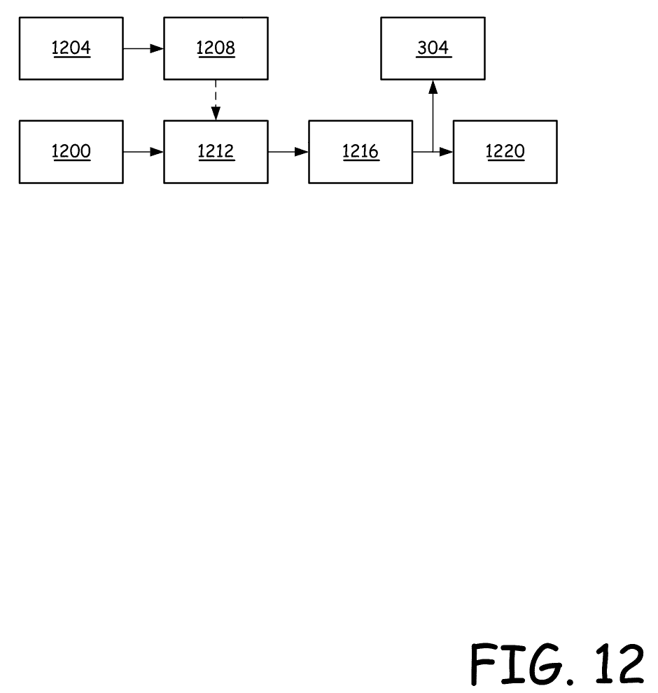

The defect detection and classification process will now be explained in detail to further clarify the disclosed method and apparatus, the system parameters set-up process and the inter relation between the set-up process and the defect detection and classification process. FIG. 12 illustrates the inter relations between the setup, defect detection and classification modules.

During the set-up stage 1204 a plurality of auxiliary images will be acquired, the number of the acquired auxiliary images will be designated by n. A reduced set of the acquired auxiliary images will serve as references for the defect detection and classification processes. The number of images in the reduced set is designated by k, where k is less than n. Each auxiliary image is characterized by two attributes:

1) Local gray level value.

2) Variance of the gray levels in repeated measurements.

This plurality of auxiliary images and their respective attributes can be described by a two dimensional vector system. For example, Image Vector IV(k,2) where k is the number of auxiliary images and 2 is the number of attributes. Such vector enables differentiating between two locations in a k dimensional space using the gray levels and gray levels variance. A one dimensional statistical distance vector SDV( ) can be created by dividing the Gray Level component with the Variance component in Image Vector IV( ) corresponding for each auxiliary image.
The created distance vector SDV( ) will represent the statistical probability of miss classification of the auxiliary images since the images are characterized by a Gaussian spread function.

A setup learning or calibration process will run on a fully loaded system equipped with suitable hardware. During this process known defects will be inspected. In order to achieve maximal signal to noise ratio for each reference auxiliary image the process will optimize the imaging parameters for every illumination source for every target area. Every known defect will be mapped with an N domains differential space, where N indicates the number of reference auxiliary images.

A reference defect vector will be created and denoted by DV( ), each member in the vector representing a parameter related to a reference auxiliary image (1-N). Each member in the vector DV( ) vector represents the distance between the nominal gray level value denoted by NI(i) and the defect gray level value denoted by DI(i) divided by the variance of NI(i) denoted by VNI(i). This enables a DV( ) vector structure to be created as follows:

DV{[NI(1)−DI(1)]/VNI(1)[NI(2)−DI(2)]/VNI(2), . . . [NI(n)−DI(n)]/VNI(n)}.

At the end of the process a set of reference area type images to be used during the defect detection and classification process will be selected. These auxiliary image selection criteria will include the following factors:

1. The summary of all auxiliary images integration times (SITDDC—Summary Integration Time Defects Detection & Classification) is no longer then the line time allowed by the application.

2. The longest distance out of a group representing the shortest distances measured in vector DV( ). The distances are measured between all of the points of interest, for example: defects from their nominal locations and defects from other defects.

3. This shortest distance mentioned above is more then a given threshold, the threshold is at least 3.

The set-up process will also identify reference auxiliary images to be used for the purpose of geometrical measurements. For every target area type the process will identify all its neighboring area types. In addition, borders between the area type and the neighboring area types will be identified and mapped into an N domains differential space to create a border vector. (N is the number of auxiliary images). The boarder vector is denoted by BVAt1-At2( ). At1 represents an image area type whereas At2 is a neighboring image area type to At1. The vector BVAt1-At2 ( ) is comprised of elements representing the distances between nominal gray levels of image area type At1 and neighboring image area type At2 divided by maximal variance between At1 and At2 and is computed for every reference auxiliary image. The nominal gray level value for At1 and At2 in for an auxiliary image I will be denoted respectively as NI At1(i), NIAt2(i) and their maximal variance as VNIAt12(i). Thus creating a border vector BVAt1-At2( ) structured as follows:

BVAt1−At2{[At2At1(1)−NIAt2(1)]/VNIAt12(1)[NIAt1(2)−NIAt2(2)]/VNIAt12(2), . . . [NIAt1(n)−NIAt2(n)]/VNIAt12(n)}.

At the end of the setup process a set of reference auxiliary images to be used during the geometrical measurements of this job will be selected. The auxiliary images selection criteria will include the following factors:
1. The summary of all auxiliary images integration times (SITGM—Summary Integration Time of Geometrical Measurements) is not longer than the line time allowed by the linear speed of the production line. Where both defects detection & classification and geometrical measurements should be preformed simultaneously, then SITGM+SITDDC should be no longer then the line time allowed by the application.
2. The longest distance out of a group of shortest distances measured in vector BVAt1-At2. The distances are measured between all the points of interest; borders distance between area types and their neighbors.
3. This shortest distance mentioned above is more than a given threshold, where the threshold is at least 3.
Defect classification according to the disclosed above process becomes a relatively simple vector procedure, which could be performed faster than non-vector based defect classification procedures.

The setup process 1204 produces reference information 1208 to be used for defect detection and defect classification during job production process. The reference information 1208 is comprised of a selected minimal set of auxiliary images enabling defect detection and classification, a reference vector for every area type at its nominal production conditions and reference vector for every defect. The reference information 1208 is forwarded to detection module 1212 and classification module 1216. The detection reference information 1208 will also include a reduced list of auxiliary images which will be sufficient for performing defect detection. Working on a reduced list of auxiliary images will increase the processing performance of the detection module 1212. The classification reference information 1208 will also include the vectors for all known defects and area types.

During job production, images of TF layer are acquired. The defect detection module 1212 performs an analysis on the job description parameters 1200 of the incoming job, to identify the area types in the reference auxiliary images.

The defect detection module 1212 measures the gray level value of the acquired pixel and the difference between the actual value and the expected value according to the expected area type at that pixel. If the measured difference exceeds a given threshold then the detection module 1212 will calculate the vector distance between the nominal location of the area type and the pixel location on the vector. In a case where this distance is within a permitted threshold then no defect is detected and the process is repeated for the next pixel. Otherwise, a defect is detected and the system will proceed to the classification stage.

Each detected defect is submitted to the defect classification module 1216 for classification. During classification the classification module 1216 identifies the area type at which the defect originated. The classification module 1216 measures the distance between the average defect location on the vector and with all the defect types previously identified on that inspected area type at the setup process. The classification module picks the closest defect type which stands within the tolerances defined for that defect type and classifies it as such. In the case where the classification module is unable to reach an obvious result the defect is classified as an “other defect”. The defect classification information along with the detected defects locations may be submitted to an upstream production steps 304 (FIG. 3) or downstream to a repair station 312 for TF layer repair.

Production line 300 or a similar line equipped with system 308 and proper repair devices could be used to improve thin layer production yield. Thin layer process defects could be identified according to one of the sequential or concurrent image acquisition methods disclosed above. Identified defects could be tagged according to a set of pre-determined production defects references and communicated to the upstream production steps 304 where some parameters of the production process would be changed or downstream to a repair station. The process of analyses of the tagged defects is performed without interrupting the movement of the production line. The defects are classified and repair instructions issued and communicated to at least one repair station on the type of repair to be performed.

There may be a number of image quality control stations on each production line. The stations may have a different set of illumination sources and operate at different resolution. The stations may communicate between them. For example, an upstream located station may detect certain defects, communicate them to a downstream station and request a more thorough control sequence with a different illumination source combination or higher resolution. The communication between the stations may trigger for example a metrology system for layer thickness measurement or other parameters control. The stations may communicate to each other images captured at different resolutions or illumination sources and process them in a synchronous mode.

There may be a variety of repair station types on the production floor. A repair station for coating layer defects correction would typically include a communication facility for receiving defect location coordinates. The station may be a node on the communication network connecting on-line all or most of the production and engineering equipment related to the process or have a device for reading removable storage media on which results of quality control process have been recorded.

Repair station may be part of production line 300 (On-line TF repair station, FIG. 3) or added (Stand alone) to the existing production lines and have its autonomous TF layer 440 translation facility such as an X-Y moving table or a conveyor belt and at least one of material deposition device or material removal device. Repair material deposition device may be such as an inkjet device, thermal transfer device or laser activated material deposition device. Material or impurities removal device would typically be a laser removal device.

The disclosed method and apparatus support operation of system 308 (FIG. 3) with any number of illumination sources or combinations thereof. It produces a number of perfectly aligned, down to a fraction of a pixel, auxiliary images.

The operation of the systems disclosed according to the method described will control each of the individually acquired images produced by different illumination sources to provide full dynamic range of each and every one of the images regardless of the differences that may exist in combined illumination intensity and sensor sensitivity.

The disclosed method and system are operative for all optical illumination field set-ups such as bright field, diffusive illumination, dark field, backlit and other illumination types and schemes, as well as in different spectral zones like IR, UV, and specific colors. It is applied to different physical phenomenon like florescence material reaction to UV light, polarization effects and others, as long as the sensible energy emission disappears during the transition between the time slices.

Although demonstrated on thin layer photovoltaic coatings manufacture the method and system are applicable to wafer based photovoltaic products, crystalline and polysilicon coatings and almost every large format articles manufacturing processes such as Flexible Displays and e-Paper, RFID (passive and active antennae), OLEDs and others.

While the exemplary embodiment of the method of and apparatus for improving production yield of thin layer based products have been illustrated and described, it will be appreciated that various changes can be made therein without affecting the spirit and scope of the method. The scope of the method, therefore, is defined by reference to the following claims:

What is claimed is:

1. A method for thin film quality control, said method comprising:
providing a continuously moving thin film and an image acquisition system;
illuminating by at least one illumination source a target area of the continuously moving thin film and acquiring at least one auxiliary image of the target area;
illuminating by another illumination source, having at least one illumination parameter different from the first source the same target area of the continuously moving thin film and acquiring at least one additional auxiliary image of the same target area;
producing a phase correction factor compensating for phase shift caused by the thin film movement between the auxiliary images acquired and initiating pointers to each of the auxiliary images;
applying the phase correction factor to the acquired auxiliary images and combining the images into a single image;
classifying the defects present in the combined image by determining deviations of the acquired images from a predetermined defect free image and determining the coordinates of the defects; and
wherein the deviations indicate the thin film quality.

2. The method according to claim 1 wherein the phase shift between the auxiliary images is one of a group consisting of phase shift for sequentially illuminated and acquired images or concurrently illuminated and acquired images.

3. The method according to claim 2 wherein the phase shift for sequentially acquired images is equal to the quotient of a sum of time slices set by the operation of each illumination source divided by the line time with the quotient multiplied by pixel size.

4. The method according to claim 2 wherein the phase shift for concurrently acquired images is equal to a product of multiplication of time slices set by operation of each illumination source divided by the line time with the quotient multiplied by pixel size and subtracted from a unit.

5. The method according to claim 1 further comprising a process of system parameters set-up preceding the process of the thin film quality control the process including at least one of a group of parameters consisting of setting a list of auxiliary images to be used for a current job and operating parameters of said images such as target area type, and illumination type.

6. The method according to claim 5 wherein the process of system parameters set-up includes an algorithm for image geometrical parameters measurement.

7. The method according to claim 1 further comprising communicating the type of the defects and their coordinates to a defect repair station configured to repair at least one of the defects.

8. The method according to claim 1 wherein each of the illumination sources is operating for at least one time slice and wherein the duration of the time slice is different for each of the illumination sources.

9. The method according to claim 1 wherein the target area is a line.

10. The method according to claim 1 wherein the processes of illuminating the thin film by illumination sources, acquiring auxiliary images including the auxiliary image of an additional target area of the thin film, producing a phase correction factor, initiating pointers to each of the auxiliary images acquired, applying correction factor to the additional thin film target area, combining said images into a single image; and determining deviations of said images are concurrent processes.

11. A method for thin film target area image acquisition using a plurality of illumination sources, said method comprising:
illuminating the target area with at least two illumination sources and operating each of the illumination sources for a pre-determined period, the duration of the period of one of the illumination sources being different from the period of the other illumination source;
acquiring auxiliary images of the target area corresponding to each of the illumination sources and combining the auxiliary images into one combined image; and
wherein the illumination sources have at least one common operational period, the common operational period being shorter than the total sum of the periods required to illuminate the target area.

12. The method according to claim 11 wherein said image data is acquired into an analog shift register configured to store the auxiliary images.

13. The method according to claim 12 wherein the time for reading the data from the analog shift register and storing the data into an image storage facility is less than the common operational period.

14. A method of yield enhancement in a thin film production process, said method comprising:
providing at least one continuously moving thin film coated substrate and an automatic thin film quality control apparatus;
acquiring at least two images of the same area of the thin film illuminated by at least two illumination sources having at least one different illumination parameter;
combining at least two images into a single image and determining the thin film defects present in the combined image and their location on the thin film;
comparing the combined image with a predetermined defect free image and communicating the type and coordinates of the defects to at least one of a group of stations consisting of:
upward located production stations,
backward located production stations or
repair stations located in-line or off-line with the thin film production stations; and
correcting at least one of the detected thin film defects.

15. The method according to claim 14 wherein correcting at least one of the detected thin film defects is by material deposition by at least one of a group consisting of an inkjet printing device, material thermal transfer device, or a laser ablation device.

16. The method according to claim 14 wherein correcting at least one of the detected thin film defects is by a laser beam removing excessive material and impurities from the thin film.

17. A method for concurrent image acquisition of a target area using a plurality of illumination sources, said method comprising:
illuminating said target area with at least two illumination sources with each source having at least one operational parameter different from the other source, and operating each of said illumination sources for a pre-determined period;
forming an image of the target area by combining auxiliary images of the same target area produced separately by each of the illumination sources; and
wherein the illumination sources have at least one common operational period and where the common operational period is shorter than the total sum of the operational periods required to illuminate the target area.

18. A system for thin film production yield enhancement, said system comprising;
a support configured to move the thin film continuously;
one or more illumination sources configured to produce on the moving thin film at least one of a bright field illumination, a dark field illumination, a backlit illumination and wherein each source has at least one different operational parameter consisting of at least one of a group of source intensity, wavelength, polarization, incidence angle, and duration different from the other source;
an image acquisition device configured to acquire at least two auxiliary images with each image produced by a different illumination sources and combine the acquired auxiliary images into a single image;
a processor for operation sequence control and acquired images processing configured to detect the thin film defects;
a plurality of communication links enabling communication to upstream or downstream located production stations and with a repair station; and
wherein the repair station is configured to repair the thin film defects.

19. The system according to claim 18, wherein the repair station is repairing the thin film defects by material deposition or material removal.

20. The system according to claim 19 wherein the material deposition is performed by at least one of a group of devices consisting of an inkjet printing device, material thermal transfer device, or a laser ablation device.

21. The system according to claim 19 wherein the material removal is performed by a laser beam providing device.

22. The system according to claim 18, wherein the illumination sources are configured to operate at least one time slice with the slice duration different for each of the illumination source.

23. The system according to claim 18, wherein the illumination sources are configured to illuminate a line equal to at least the thin film width.

24. The system according to claim 18 wherein the image acquisition device is configured to acquire concurrently at least two auxiliary images and simultaneously analyze the acquired images for detection of defects and defects classification.

25. A process of a thin film quality control system parameters set-up, said process comprising:
acquiring a plurality of auxiliary images to serve as references for defect detection and classification processes and characterizing each image by:
local gray level value
variance of the gray levels in repeated measurements
differentiating between at least two acquired images by using the gray level values and variance of the gray levels
creating a one dimensional statistical distance vector SDV( ).

26. The process according to claim 25, wherein the dimensional statistical distance vector SDV( ) is created by dividing the gray level component with the variance component in image vector IV( ) corresponding to each auxiliary image.

27. The process according to claim 25 further comprising creating a reference defect vector DV( ), with each member in the vector DV( ) vector representing the distance between the nominal gray level value NI(i) and the defect gray level value DI(i) divided by a variance of the nominal gray level value NI(i).

28. The process according to claim 25 further comprising selecting a set of image area types to be used for the defect detection and classification process the images corresponding to at least the following criteria:
a summary of all auxiliary images integration times (SITDDC) is no longer than the line time allowed by an application;
a longest distance out of a group representing the shortest distances measured in vector DV( );
the shortest distance out of a group representing the shortest distances measured in vector DV( ) is more than a given threshold, the threshold being is at least 3.

29. The process according to claim 25 further comprising identifying reference auxiliary images to be used for geometrical measurements by:
identifying for every target image area the all-neighboring image area types;
identifying and mapping borders between the neighboring image area types; and
creating for each auxiliary image a border vector (BV(Aₜ₁-Aₜ₂)), the vector comprising elements representing a distance between nominal gray level values of an image area type (Aₜ₁) and neighboring image area type (Aₜ₂) divided by maximal variance between the image areas type (Aₜ₁) and (Aₜ₂).

30. The process according to claim 29 wherein the reference auxiliary images for the geometrical measurements are selected according to the following factors:
summary of all auxiliary images integration times (SITGM) is not longer than a line time allowed by linear speed of a production line;
the longest distance out of a group of the shortest distances measured in the boarder vector (BV(Aₜ₁-At₂));
the shortest distance is greater than a threshold, the threshold being at least 3.
